(19) United States
(12) Patent Application Publication
(10) Pub. No.: US 2002/0118381 A1
(43) Pub. Date: Aug. 29, 2002

(54) Color-correcting method and color-correcting system

(75) Inventors: Koichi Shirai, Shinjuku-Ku (JP); Naoji Shibasaki, Shinjuku-Ku (JP); Mitsuhiro Hamashima, Shinjuku-Ku (JP); Takayuki Ohkubo, Shinjuku-Ku (JP)

Correspondence Address: PARKHURST & WENDEL, L.L.P., 1421 PRINCE STREET, SUITE 210, ALEXANDRIA, VA, 22314-2805, US

(73) Assignee: Dai Nippon Printing Co., Ltd., Shinjuku-Ku (JP)

(21) Appl. No.: 10/081,292

(22) Filed: Feb. 26, 2002

(30) Foreign Application Priority Data
Feb. 27, 2001 (JP) 2001-52783
Mar. 30, 2001 (JP) 2001-98805

(51) Int. Cl. B41J 1/00

(52) U.S. Cl. 358/1.9

(57) ABSTRACT

A printing apparatus is provided with an input unit (6) for inputting image data, and an output unit (12) for printing an image on the basis of the image data. The output unit (12) prints a test image represented by input image data including reference color development characteristic information stored beforehand in a control unit (2). The control unit (2) calculates output-correcting values on the basis of the difference between color development characteristic information included in image data obtained by reading the printed image by the input unit (6) and reference color development characteristic information. The control unit (2) corrects the image data input by the input unit (6) by using the output-correcting values to provide corrected image data, and the output unit (12) prints an image represented by the corrected image data.

### BACKGROUND OF THE INVENTION

1. Field of the Invention

The present invention relates to a color-correcting method and a color-correcting system to be applied to full-color printing of a sublimation dye transfer printing system.

2. Description of the Related Art

Full-color sublimation dye transfer printing apparatuses that form a full-color image on a recording medium by transferring subliming dyes to the recording medium according to recording signals provided by a thermal print head are used widely as color-image output devices for printing proofs, medical images, digital photographs and amusement photographs.

Quality of subliming dyes varies in a certain range because subliming dyes are industrial products, and operations of printers include errors. Therefore, images printed respectively by using subliming dyes of different batches and printers of different production lots and by feeding the same image signals to those printers differ in color characteristics.

Since the colors of an image is dependent on the color-developing characteristics of dyes, a test image must be printed and manual color correction must be made to print images of desired color characteristics. The maintenance of the printer needs some knowledge and experiences and requires troublesome work.

### SUMMARY OF THE INVENTION

The present invention has been made in view of the foregoing circumstances and it is therefore an object of the present invention to provide a color-correcting method and a color-correcting system capable of reducing the difference of the color-developing characteristic of a printer from a reference color developing characteristic, and of being easily maintained by a person with little knowledge and experience.

According to a first aspect of the present invention, a color-correcting method includes the steps of: inputting image data into an input unit; correcting the image data input into the input unit by using output-correcting values by a controller to obtain color-corrected image data; and printing an image represented by the color-corrected image data corrected by the controller by an output unit.

The color-correcting method may further include the steps of: printing a test image by the output unit on the basis of test image data carrying reference color development characteristic information; reading the printed test image by the input unit to obtain image data; and calculating the output-correcting values by the controller on the basis of the differences between the color development characteristic information included in the test image data read by the input unit and the reference color development characteristic information.

The present invention prints a test image represented by the test image data carrying the reference color development characteristic information, calculates the output-correcting values on the basis of the of differences between the color development characteristic information included in the test image data read by the input unit and the reference color development characteristic information and corrects output colors. For example, if the colors of a printed image printed by a printer differ from reference colors owing to the color-developing characteristics of the printer, the output colors are corrected by the color-correcting method of the present invention to reduce the difference of the colors of the printed image from the reference colors.

According to a second aspect of the present invention, a color-correcting system includes an input unit that receives image data; a controller storing output-correcting values, for correcting the image data received by the input unit by using the output-correcting values; and an output unit that prints an image on the basis of the corrected image data obtained by correcting the image data by the controller.

The controller has test image data including reference color development characteristic information, the input unit reads a test image printed on the basis of the test image data by the output unit, and the controller calculates output-correcting values on the basis of the difference between the color development characteristic information included in the test image data read by the input unit and the reference color development characteristic information.

According to the present invention, an image represented by the test image data including the reference color development characteristic information is printed out, the output-correcting values is calculated on the basis of the difference between the color development characteristic information included in the printed image data and the reference color development data to correct printed colors. Therefore, the difference between the colors of the printed image and the reference colors owing to the color development characteristics of the printer can be reduced. Generally, the manufacturer of the printer corrects the output colors when initializing the printer. However, the maintenance of the color-correcting system of the present invention can be easily achieved by a person not having any knowledge and experience because the color-developing characteristics can be corrected by operations specified on a screen.

Since the input image data is corrected by using the output-correcting values to correct output colors, and then an image is printed, it is possible to reduce the difference of colors printed by the printer from the reference colors owing to the difference between the color-developing characteristics of the printer and the reference color developing characteristics.

In the color-correcting system according to the present invention, the controller may change the output-correcting values according to printing conditions.

In the color-correcting system according to the present invention, the controller may store a plurality of sets of output-correcting values and may select an appropriate set of output-correcting values according to printing conditions.

In some cases, proper output-correcting values cannot be provided due to the variation of the quality of dyes and the change of the ability of the printer with time. Thus the present invention is able to change the output-correcting values according to the change of dyes and to store changed output-correcting values, or to change the output-correcting values according to operating time whenever the occasion demands and to store the changed output-correcting values. Thus proper output-correcting values can be read according to printing conditions, and an image of the same color-developing characteristics as the reference color developing characteristics stored in a storage device and be printed.

Proper output-correcting values is chosen from the stored output-correcting values according to a printing state, such as a state where a main switch is closed, a state where an image data recording medium is being changed, a state where parts of the printer is being changed or the like, and the chosen output-correcting values is used for output correction to reduce the difference between the color-developing characteristics and the reference color developing characteristics can be reduced.

In the color-correcting system according to the present invention, the output unit may be a sublimation dye transfer printer.

According to the present invention, color-correcting functions are incorporated into a printing apparatus provided with a sublimation dye transfer printer to reduce the difference between the color-developing characteristics and the reference color developing characteristics.

According to a third aspect of the present invention, a color-correcting method includes a step of reading a printed image by an input unit to obtain image data, and a step of modifying the image data read by the input unit by a controller by using color modification parameters corresponding to a printing system by which the printed image was formed.

The color-correcting method according to the present invention may further include a step of identifying the printing system by which the printed image was formed and specifying desired color modification parameters by the controller.

Thus, the colors specific to the printing system are corrected to reproduce an image of the same colors as those of an original image.

According to a fourth aspect of the present invention, a color-correcting system includes an input unit that reads a printed image to obtain image data, and a controller that modifies the image data provided by the input unit by using color modification parameters corresponding to a printing system by which the printed image was formed.

In the color-correcting system according to the present invention, the controller stores a plurality of sets of color modification parameters respectively corresponding to a plurality of printing systems, identifies a printing system by which the printed image was formed, and specifies a desired set of color modification parameters.

The color-correcting system according to the present invention may further include an output unit that prints an image on the basis of the image data modified by the controller.

According to the present invention, the difference between the colors specific to the printing system and the reference colors can be modified and hence an image of the same colors as those of an original image can be reproduced when printing an image of a printed image, such as a photographic image.

In the color-correcting system according to the present invention, the input unit may be a flat-bed scanner.

The flat-bed scanner, as compared with a drum scanner, can be easily used because the flat-bed scanner does not require work for attaching an original print to a drum and adjusting illumination.

In the color-correcting system according to the present invention, the controller identifies a printing system by which the printed image was formed on the basis of external data given thereto.

According to the present invention, data representing the printing system may be input or selected by operating a keyboard or a mouse to facilitate the identification of the printing system.

In the color-correcting system according to the present invention, the controller may identify the printing system by which the printed image was formed on the basis of electronic watermark information included in the image data obtained by reading the printed image.

According to the present invention, the electronic watermark information about the printing system is recorded previously in the original image, and the printing system may be identified by the electronic watermark information about the printing system.

In the color-correcting system according to the present invention, the controller identifies a printing system by which the printed image was formed on the basis of information provided by an information storage medium storing printing systems by which printed images were formed.

According to the present invention, an image to be printed may be accompanied by an information recording medium storing information about a printing system by which the image is formed, and the information about the printing system may be read from the information recording medium accompanying the image. Thus the printing system can be easily identified.

In the color-correcting system according to the present invention, the controller may modify the image data provided by the input unit by using color modifiction parameters stored therein.

### BRIEF DESCRIPTION OF THE DRAWINGS

FIG. 1 is a block diagram of a printing apparatus in a first embodiment according to the present invention;

FIG. 2 is a perspective view of a main unit included in the printing apparatus in the first embodiment;

FIG. 3 is a flow chart of an initializing procedure to be carried out by the printing apparatus in the first embodiment;

FIG. 4 is a flow chart of a printing procedure to be carried out by the printing apparatus in the first embodiment after initialization;

FIG. 5 is a pictorial view of a starting picture displayed on the touch panel of a monitor included in the printing apparatus in the first embodiment;

FIG. 6 is a pictorial view of a main menu picture displayed on the touch panel of the monitor of the printing apparatus in the first embodiment;

FIG. 7 is a pictorial view of an image data source menu picture displayed on the touch panel of the monitor of the printing apparatus in the first embodiment, showing image data sources;

FIG. 8 is a pictorial view of a size menu picture displayed on the touch panel of the monitor of the printing apparatus in the first embodiment, showing sizes of readable images;

FIG. 9 is a pictorial view of an operator guidance picture displayed on the touch panel of the monitor included in the printing apparatus in the first embodiment, prompting an operation to operate a scanner for reading an original picture;

FIG. 10 is a pictorial view of an image adjustment guidance picture displayed by the printing apparatus in the first embodiment;

FIG. 11 is a pictorial view of a quantity specifying picture displayed by the printing apparatus in the first embodiment, requesting specifying the number of prints;

FIG. 12 is a pictorial view of an accounting picture for requesting payment displayed by the printing apparatus in the first embodiment, requesting payment;

FIG. 13 is a pictorial view of an account confirmation picture displayed by the printing apparatus in the first embodiment, showing accounting information;

FIG. 14 is pictorial view of an instruction picture displayed by the printing apparatus in the first embodiment, prompting the user to remove the original picture from the scanner;

FIG. 15 is a pictorial view of a picture displayed by the printing apparatus in the first embodiment, indicating that the printing apparatus is in operation;

FIG. 16 is a pictorial view of an ending picture displayed by the printing apparatus in the first embodiment, indicating that the printing apparatus has completed a printing procedure;

FIG. 17 is a block diagram of a color-correcting system in a second embodiment according to the present invention;

FIG. 18 is a flow chart of a color-correcting procedure to be carried out by the color-correcting system in the second embodiment;

FIG. 19 is a flow chart of a printing system identifying procedure to be carried out by the color-correcting system in the second embodiment;

FIG. 20 is a flow chart of a printing system identifying procedure to be carried out by the color-correcting system in the second embodiment to identify printing system on the basis of image information about an original picture;

FIG. 21 is a flow chart of a printing system identifying procedure to be carried out by the color-correcting system in the second embodiment to identify printing system on the basis of an electronic watermark information included in an original picture;

FIG. 22 is a flow chart of a printing system identifying procedure to be carried out by the color-correcting system in the second embodiment to identify printing system on the basis of data recorded in a recording medium accompanying an original image;

FIG. 23 is a block diagram of a printing apparatus forming the color-correcting system in the second embodiment; and

FIG. 24 is a perspective view of the printing apparatus shown in FIG. 23.

### DESCRIPTION OF THE PREFERRED EMBODIMENTS

First Embodiment

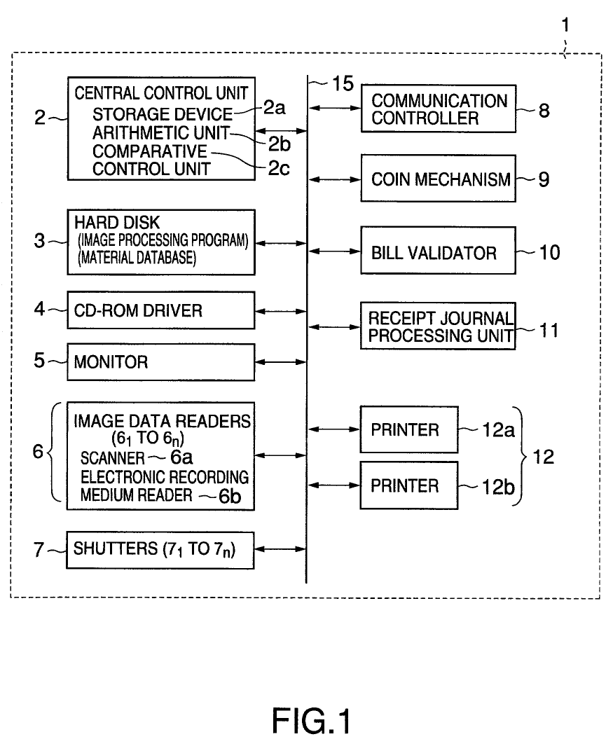

A printing apparatus (color-correcting system) in a first embodiment according to the present invention having a color-correcting function will be described hereinafter. Referring to FIG. 1, a main unit 1 included in the printing apparatus (color-correcting system) in the first embodiment for carrying out a color-correcting method according to the present invention includes a central control unit (controller) 2 having a storage device 2a, an arithmetic unit 2b and a comparative control unit 2c, an input unit 6 including n image data readers 6₁ to 6ₙ, an output unit 12 including printers 12a and 12b, a hard disk 3, a CD-ROM driver 4, a monitor 5 provided with a touch panel, n shutters 7, a coin mechanism 9, a bill validator 10, a receipt journal processing unit 11, a communication controller 8, and a bus 15 interconnecting those components.

The input unit 6, i.e., an image data read unit, includes the n image data readers 6₁ to 6ₙ of different systems respectively for different image data recording mediums. A user is able to enter image data recorded on an image data recording medium brought with the user by using one of the image data readers, suitable for reading the image data. Each of the image data readers 6₁ to 6ₙ may be a scanner 6a that reads an analog image data and provides digital image data or an electronic image data recording medium reader 6b capable of reading digital image data recorded on an electronic image data recording medium. The electronic image data recording medium stores digital image data obtained by subjecting an analog image to a digital conversion process. The electronic image data recording medium is, for example, a floppy disk (abbreviated to “FD”), a PC card, a smart card or a compact flash memory card (CF card).

The output unit 12 includes output devices for printing the input image data. The output devices are the printers 12a and 12b. Preferably, the printers 12a and 12b are sublimation dye transfer printers.

The central control unit 2 is a computer including the storage device 2a, the arithmetic unit 2b and the comparative control unit 2c.

Test image data including reference color development characteristic information for test printing is stored beforehand in the storage device 2a. The comparative control unit 2c compares image information provided by the scanner or the electronic image data recording medium with the reference color development characteristic information stored beforehand in the storage device 2a. The arithmetic unit 2b calculates, on the basis of the results of comparison made by the comparative control unit 2c, output-correcting values corresponding to the difference between the predetermined reference color development characteristic information and the color development characteristic information of a printed image printed by the printer of the main unit. The output-correcting values are stored in the storage device 2a. These output-correcting values are used after initialization for correcting input image information to provide proper image information.

Various pieces of measured element information (100%-dye mode, operating time and the like) are stored together with the output correcting values in the storage device 2a. For example, sometimes, the color development of a printed image formed in a 100% dye injection mode and that of a printed image formed in a 50% die injection mode even on the basis of the same image signal are different. Therefore, the output-correcting values are changed according to the element information and the changed output-correcting values may be stored in the storage device 2a whenever necessary.

A plurality of sets pf output-correcting values may be stored for the element information and a proper set of output-correcting values for the element information (conditions) may be read. Since proper image information can be obtained by using the read output correcting values, the color development characteristic of the printed image is not different from the reference color development characteristic.

The components of the main unit 1 interconnected by the bus 15 are controlled according to programs stored in the hard disk 3, i.e., a large-capacity data storage medium. Control programs for controlling the components of the main unit 1, such as a read program for reading information from the image data recording mediums, a shutter control program, an accounting program, a color correction program, an image processing program and such are stored in the hard disk 3. Those programs are called and executed when necessary.

The CD-ROM driver 4 is used for the version-up of the programs or information stored in the storage device 2a and the hard disk 3 of the main unit 1; a CD-ROM for version-up is loaded to the CD-ROM driver 4 and data is rewritten.

The monitor 5 provided with a touch panel displays operating procedures for executing the programs stored in the hard disk 3. Selecting and executing operations are executed according to an operating procedure displayed by the monitor 5 to carry out a series of operations including those for reading image data and printing an image.

The shutters 7 (7₁ to 7ₙ) are disposed at the image data recording medium receiving slots of the image data readers 6₁ to 6ₙ, respectively. The shutters 7 shut the image data recording medium receiving slots to inhibit taking image data recording mediums from the corresponding image data readers 6₁ to 6ₙ.

The coin mechanism 9, the bill validator 10, and the receipt journal processing unit 11 are used for carrying out an accounting procedure. The coin mechanism 9 and/or the bill validator 10 executes accounting operations including those for inspecting coins and bills for genuineness, identifying denominations of coins and bills, calculating an amount of money, giving change and the like. The receipt journal processing unit 11 prints a print menu, the amount of money paid and the like on a receipt sheet and delivers a receipt. When demand for payment is unnecessary, the printing apparatus may be set so as to omit the accounting procedure.

The communication controller 8 can be connected to external terminal devices. An external terminal device can be connected through the communication controller 8 to the printing apparatus to print images by operating the external terminal device.

As shown in FIG. 1, the printing apparatus includes the input unit 6 for entering image data, and the output unit 12 for printing an image represented by the input image data, and the test printing image data having the reference color development characteristic information is stored beforehand in the storage device 2a. A test image is printed on the basis of the image data having the reference color development characteristic information, the input unit 6 reads the test image, the central control unit 2 calculates output-correcting values on the basis of the difference between the color development characteristic information about the printed test image, and the reference color development characteristic information. Image data for the following printing cycles are processed for output color correction.

The printing apparatus includes the input unit 6 for entering image data, and the output unit 12 for printing an image represented by the input image data, and the output-correcting values are stored beforehand in the storage device 2 and image data is processed for output color correction on the basis of the image data read by the input unit 6 and the output correcting values. The thus corrected image data is used for printing. Output correcting values can be stored in the storage device 2a whenever necessary as time passes. A proper one of the output-correcting values stored in the storage device 2a can be chosen according to conditions.

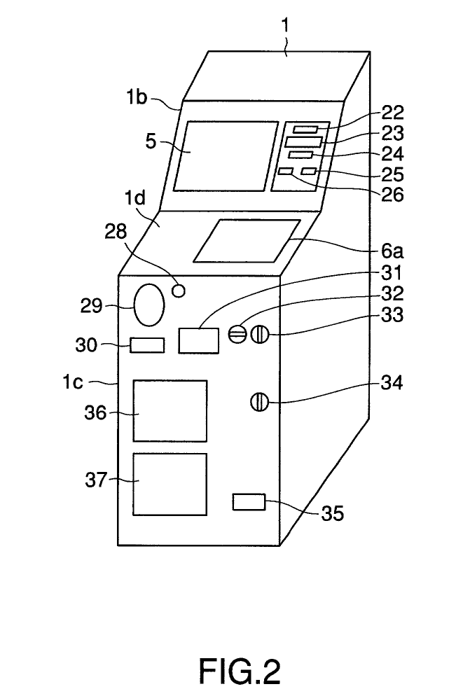

Referring to FIG. 2 showing the main unit 1 of the printing apparatus (color-correcting system), the touch panel of the monitor 5 is placed on the front wall of an upper part 1b of the main unit 1. The touch panel is the screen of a CRT or a liquid crystal display panel. The monitor 5 serves both as a display means for displaying operation guidance, condition of operations, input or processed image and such, and as input means for entering orders and data for color correction.

Image data recording medium receiving slots 22 to 26 for the image data readers 6₁ to 6ₙ of the input unit 6 are arranged beside the touch panel of the monitor 5. A support plate included in the scanner 6a for reading a printed image, and converting printed image into digital image data is disposed on a horizontal part 1d between the upper part 1b and a lower part 1c of the main unit 1.

More concretely, the image data recording medium receiving slots 22 to 26 are a floppy disk insertion slot 22, a CD-ROM insertion slot 23, a PC card insertion slot 24, a smart card insertion slot 25 and a compact flash memory insertion slot 26. The slots 22 to 26 are covered with the protective shutters 7, not shown in FIG. 2.

A maintenance key 28, a loudspeaker 29, a coin deposition slot 33, a coin returning lever 32, a bill deposition slot 31, a change outlet 35, a receipt outlet 30, a reference print outlet 36 for delivering a reference print, a cut print outlet 37 for delivering cut printed sheets, a front-door lock 34 are arranged on a front door covering the open front side of the lower part 1c of the main unit 1.

The maintenance key 28 is operated to select an operating mode for accepting a user or a management mode for setting the printing apparatus and carrying out maintenance work by a managing person. When the management mode is selected, color correction can be performed, when necessary, to obtain a printed image of colors corresponding to the reference color development characteristic information. The loudspeaker 29 radiates voices, background music, sound effect or the like while the printing apparatus is in waiting or in operation.

A charge is paid by depositing bills through the bill deposition slot 31 or depositing coins through the coin deposition slot 33. When the coin returning lever 32 is turned or when change is given, coins are delivered through the change outlet 35.

A receipt issuing device disposed inside the main unit 1 issues a receipt on which the amount of money collected and orders made by the user are printed, and delivers the receipt through the receipt outlet 30.

Output devices disposed inside the main unit 1 print a reference print and a cut print, and deliver the same to the reference print outlet 36 and the cut print outlet 37.

The front-door lock 34 is operated to open the front door for the maintenance of the devices installed inside the main unit 1. Installed inside the main unit 1 are parts associated with the touch panel of the monitor 5, the image data recording medium receiving slots 22 to 26 and the support plate of the scanner 61. A volume adjusting device for the loudspeaker 29 is disposed inside the main unit 1. Also installed in the main unit 1 in connection with the coin deposition slot 33, the coin returning lever 32, the bill deposition slot 31 and the change outlet 35 are coin mechanism 9 (coin processing device), for identifying, storing and delivering coins, the bill validator 10 (bill processing device) and a safe for storing coins when the coin mechanism 9 is filled with coins up to its full capacity. A receipt printer is combined with the receipt outlet 30. A printer is combined with the reference print outlet 36 and the cut print outlet 37.

Although not visible from outside, a microcomputer including the central control unit (controller) 2, a power box for voltage transformation, and an uninterruptive power supply for preventing damage in the CPU of the central control unit 2 and the hard disk 3 in case of power failure are disposed inside the main unit 1.

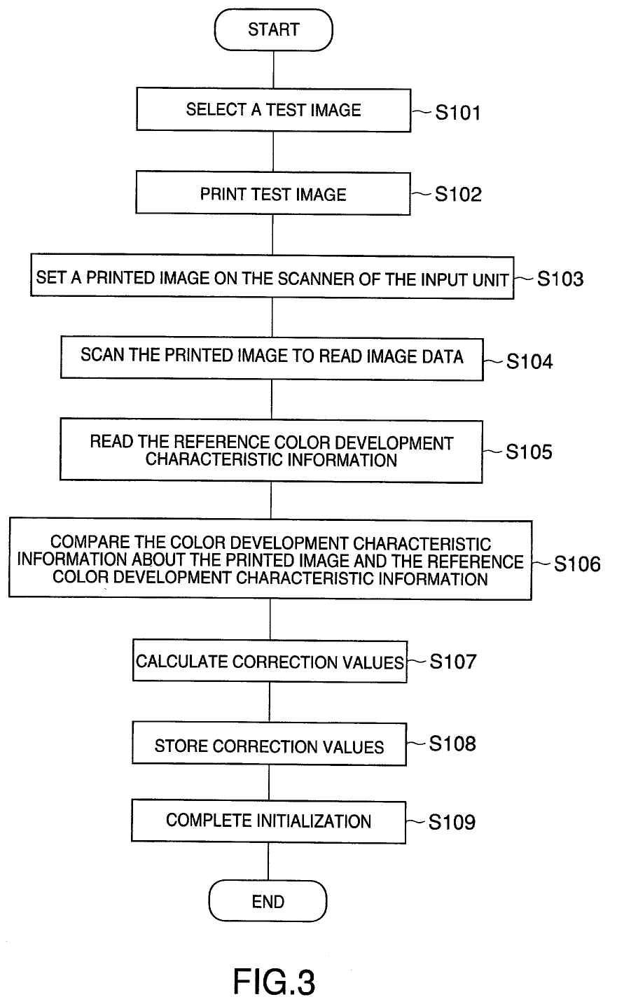

The operation of the printing apparatus will be explained hereinafter. The printing apparatus needs to be initialized by an initializing procedure to provide optimum image processing information for printing. The initializing procedure calculates output-correcting values for correcting color development characteristics to reduce the difference between the color development characteristics and the reference color development characteristics, and stores the calculated output-correcting values in the storage device 21 of the central control unit 2. The initializing procedure will be described with reference to a flow chart shown in FIG. 3.

In step S101, the touch panel of the monitor 5 is operated to select a test image. Test image data representing the selected test image is read from the storage device 2a. The test image is printed on the basis of the test image data by either the printers 12a or 12b of the output unit 12 in step S102. A printed image is set on the scanner 6a of the input unit 6 in step S103, and the scanner 61 scans the printed image to read image data representing the printed image in step S104. Then, the reference color development characteristic information is read from the storage device 2a of the central control unit 2 in step S105. The comparative control unit 2c compares the color development characteristic information about the image scanned by the scanner 6a and the reference color development characteristic information about the test image data read from the storage device 2a in step S106. If the color development characteristic information about the image scanned by the scanner 6a differs from the reference color development characteristic information about the test image data, information is given to that effect to the arithmetic unit 2b, and the arithmetic unit 2b calculates correction values in step S107. The calculated correction values are stored as output-correcting values for initialization in the storage device 2a in step S108 to complete the initializing procedure in step S106.

In some cases, the output-correcting values become improper as time passes due to the quality change of the dyes and the variation of the performance of the printer. Therefore the output-correcting values may be changed or the output-correcting values may be changed according to operating time. The output-correcting values are stored in the storage device 2a together with information about conditions when the output-correcting values are stored in the storage device 2a. Thus output-correcting values proper for printing conditions, for a state when the main switch is closed, a state when electronic image data recording mediums are changed, a state when parts of the printer are changed or the like is selectively read to print an image having the reference color development characteristics stored in the storage device 2a.

Initialization can be easily achieved by a user with little knowledge by invoking a maintenance program stored beforehand in the hard disk 3 by operating the touch panel of the monitor 5.

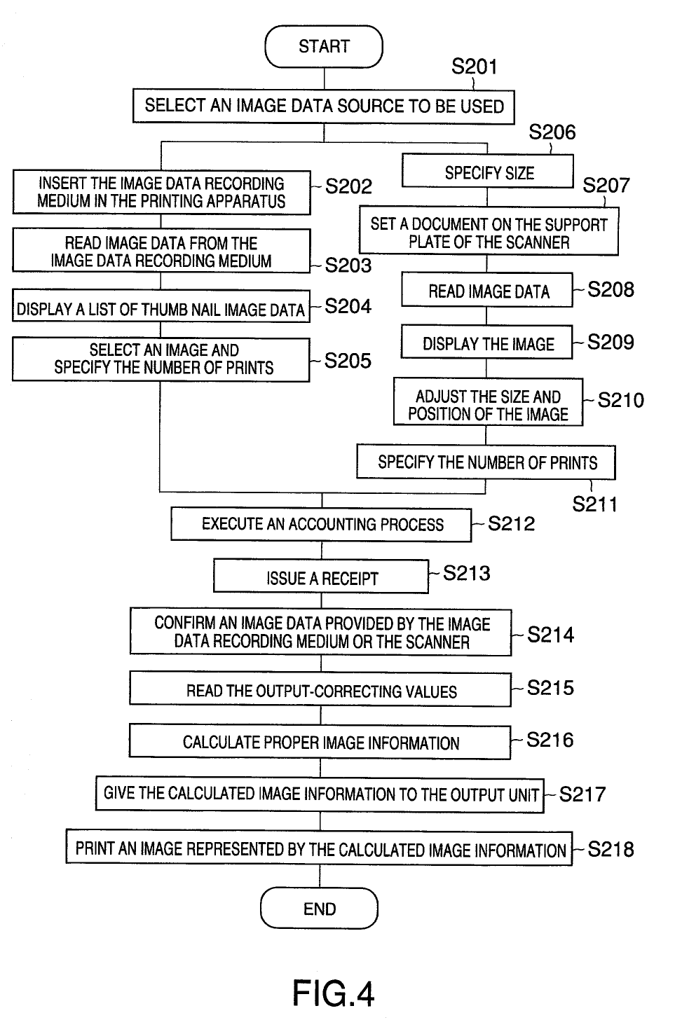

A regular printing operation will be described with reference to FIG. 4 showing a flow chart of a printing procedure to be carried out by the printing apparatus in the first embodiment after initialization on an assumption that image data is provided by an image data recording medium or by the scanner 6a. Steps of entering image data by the image data recording medium or the scanner 6a will be described. An image data source to be used is selected in step S201.

Suppose that an image data recording medium is used as an image data source. The image data recording medium is inserted through the corresponding image data recording medium receiving slot in the printing apparatus in step S202. The reader reads image data from the image data recording medium in step S203. Thumb nail image data recorded on the image data recording medium is read and is displayed in a list on the touch panel of the monitor 5 in step S204. An image to be entered and the number of prints are specified, following guidance messages displayed on the touch panel of the monitor 5 in step S205.

Suppose that the scanner 6a is used as an image data source. Then, the size on an image to be scanned by the scanner 6a is selected, following guidance messages displayed on the touch panel of the monitor 5 in step S206. A document to be scanned by the scanner 6a is set on the support plate of the scanner 6a in step S207. Then, the scanner 6a is actuated to read image data from the document in step S208, and an image represented by the image data read by the scanner 6a is displayed on the touch panel of the monitor 5 in step S209. The image displayed on the touch panel of the monitor 5 is examined, the image is enlarged, reduced, shifted and/or turned in a frame in step S210. The number of prints is specified, following guidance messages displayed on the touch panel of the monitor 5 in S211.

A printing procedure for printing the selected image will be described hereinafter. An accounting process for collecting a charge for the size and the number of prints specified in step S205 or S211 must be carried out in step S212 before starting printing the image read by the scanner 6a or the electronic image data recording medium reader 6b of the input unit 6. The price of the prints is displayed on the touch panel of the monitor 5. The user pays money for the price displayed on the touch panel of the monitor 5, and then a receipt is delivered to the receipt outlet 30 in step S213. The image data provided by the image data recording medium or the scanner 6a is confirmed in step S214 after the completion of the accounting process, and then the central control unit 2 reads the output-correcting values from the storage device 2a in step S215. Then, the arithmetic unit 2b calculates proper image information on the basis of the output correcting values and the image data in step S216. The calculated image information is given to the output unit 12 in step S217, and the output unit 12 prints an image represented by the calculated image information in step S218.

An order accepting procedure and a printing procedure to be carried out by the main unit 1 of the printing apparatus in the first embodiment will be described with reference to flow charts and pieces of information displayed on the touch panel of the monitor 5.

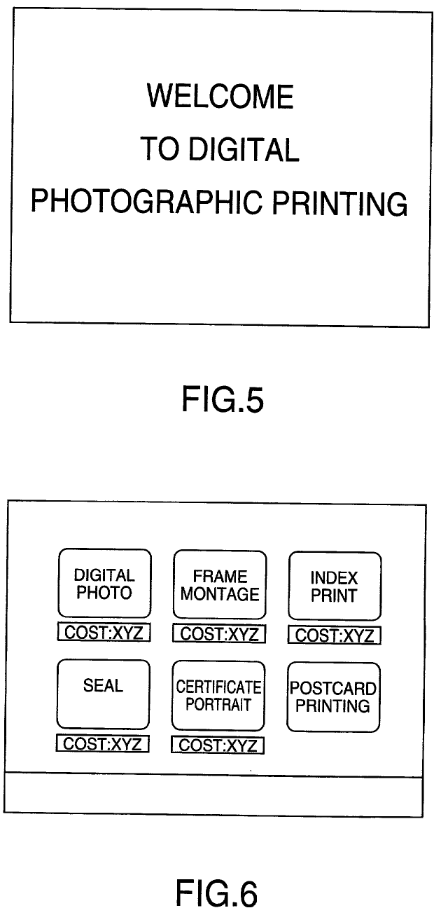

In an image print service system according to the present invention, a starting picture as shown in FIG. 5 is displayed on the touch panel of the monitor 5. A user lays a finger on any part of the starting picture, and then a main menu picture as shown in FIG. 6 is displayed. The main menu picture is displayed for a predetermined time and disappears, and the starting picture is displayed again unless any selective operation is made within the predetermined time. The main menu picture includes a list of types of prints the user can select, such as “Digital photo”, “Frame montage”, “Index print”, “Seal”, “Certificate portrait” and “Postcard printing”. Touch panel buttons for the types of prints are arranged in two lines. Suppose that “Digital photo” is selected. Operations for “Frame montage”, “Index print”, “Seal”, “Certificate portrait” and “Postcard printing” are substantially the same as the operation for “Digital photo”.

When “Digital photo” is selected, a digital photo printing procedure is started. Each of menu pictures displayed on the touch panel is provided with a cancel button and a page-up button. The starting picture is displayed when the cancel button is depressed. The preceding menu picture is displayed when the page-up button is depressed to enable retrying the preceding operation.

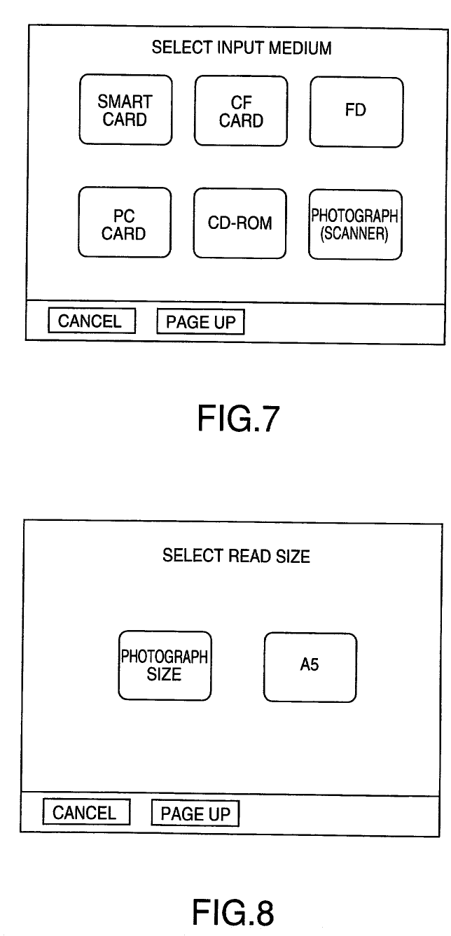

When the digital photo printing procedure is thus started, an image data source menu picture including a list of image data sources as shown in FIG. 7 is displayed. The image data source menu picture includes a message, “Select an image data source” and image data source buttons, such as a smart card button, a CF card button, a FD button, a PC card button, a CD-ROM button and a photograph (scanner) button. A desired image data source is selected by laying a finger on one of those image data source buttons.

When one of the image data sources, i.e., the smart card, the CF card, the FD, the PC card and the CD-ROM, is selected, a picture showing a method of inserting the selected image data source in the printing apparatus is displayed on the touch panel. A printing process using the scanner as image data input means will be described by way of example.

When the user lays a finger on the photograph (scanner) button shown in FIG. 7, a read size menu picture including a read size menu as shown in FIG. 8 is displayed. The read size menu picture includes a message, “Select read size”, and size buttons, such as a photograph button for selecting a photograph size, and an A5 button for selecting the size A5. A document of a size not greater than 89 mm×127 mm can be read when the photograph size is selected, or a document of a size not greater than 148.5 mm×210 mm can be read when the size A5 is selected.

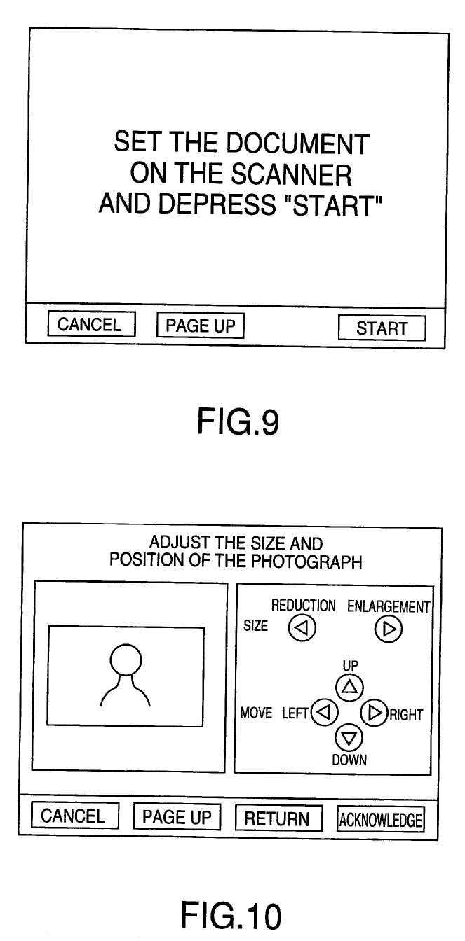

When the user lays a finger on the photograph button or the A5 button, a desired read size is selected and an operation guidance picture as shown in FIG. 9 is displayed. The operator guidance picture includes a message, “Set the document on the scanner and press start button”, a cancel button, a page-up button and a start button.

A document is set on the scanner and the start button is touched with a finger according to the guidance shown in the operator guidance picture shown in FIG. 9. Then, the scanner 6a scan the document to obtain image data. As soon as the scanner 6a completes scanning the document, an image adjustment guidance picture as shown in FIG. 10 is displayed. The image adjustment guidance picture includes a picture of an image read by the scanner 6a, a message, “Adjust size and position of the photograph”, a size adjustment panel including an enlargement button and a reduction button, a move panel including a move-up button, a move-down button, a move-to-the-right button and a move-to-the-left button, a cancel button, a page-up button, a return button, and an acknowledge button.

The size of the read image can be changed by touching the buttons included in the size adjustment panel. The position of the image can be adjusted by touching the buttons of the move panel. When the return button is touched, the image returns to its original size and its original position. The acknowledge button is touched after completing the adjustment of the size and position of the image.

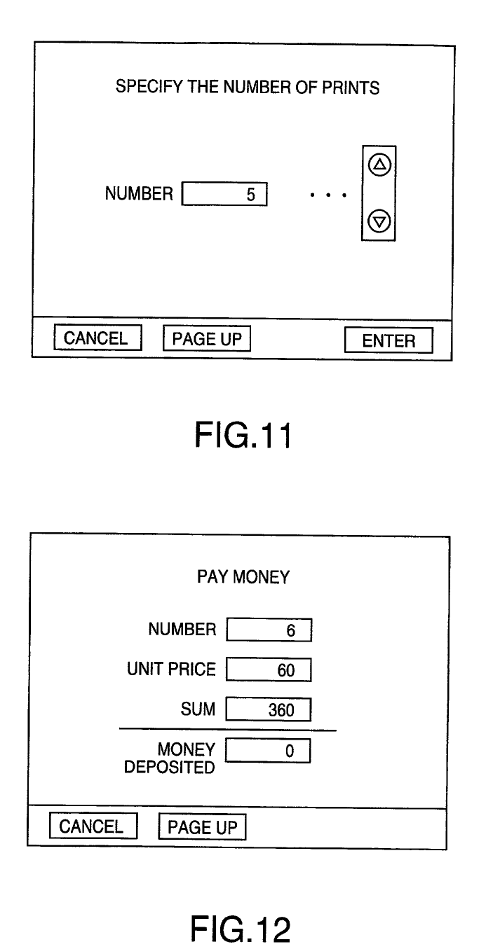

After the adjustment of the size and position of the image has been completed, quantity specifying picture as shown in FIG. 11 is displayed. The quantity specifying picture includes a message, “Specify the number of prints”, a blank for entering numerals indicating the desired number of prints, an increase button (erect triangle), a decrease button (inverted triangle), a cancel button, a page-up button, and a decision button as shown in FIG. 11. The increase button is touched to increase the number of prints or the decrease button is touched to reduce the same. An order is settled when the decision button is touched.

An accounting picture as shown in FIG. 12 is displayed after the settlement of the order to execute an accounting process.

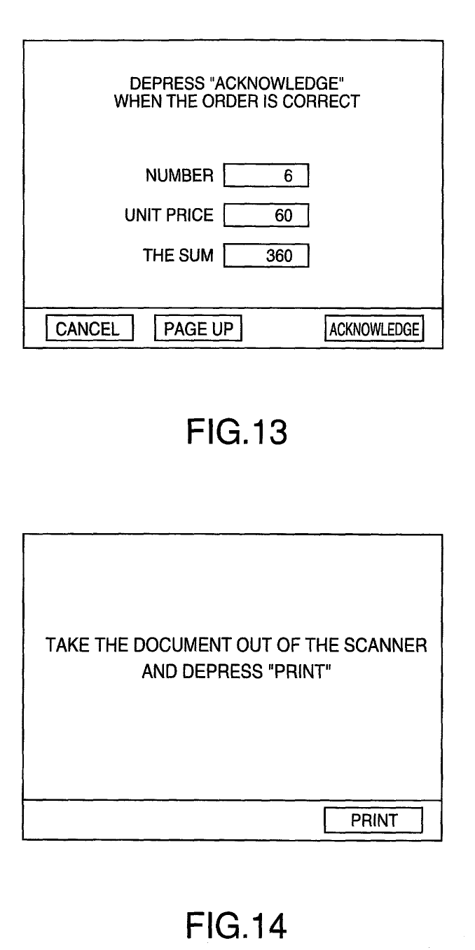

The accounting picture includes a message, “Deposit money”, number of prints, unit price, sum of money (total charge), amount of money deposited, a cancel button and a page-up button. When the amount of money deposited through the coin deposition slot 33 and/or the bill deposition slot 31 is equal to or exceeding the total charge and the printing apparatus is in a mode for only the confirmation of the sum of money, an account confirmation picture as shown in FIG. 13 is displayed. The account confirmation picture includes a message, “Push acknowledge button when the account is acceptable”, the number of prints, unit price, total charge, a cancel button, a page-up button and an acknowledge button. The accounting process is completed when the acknowledge button is touched.

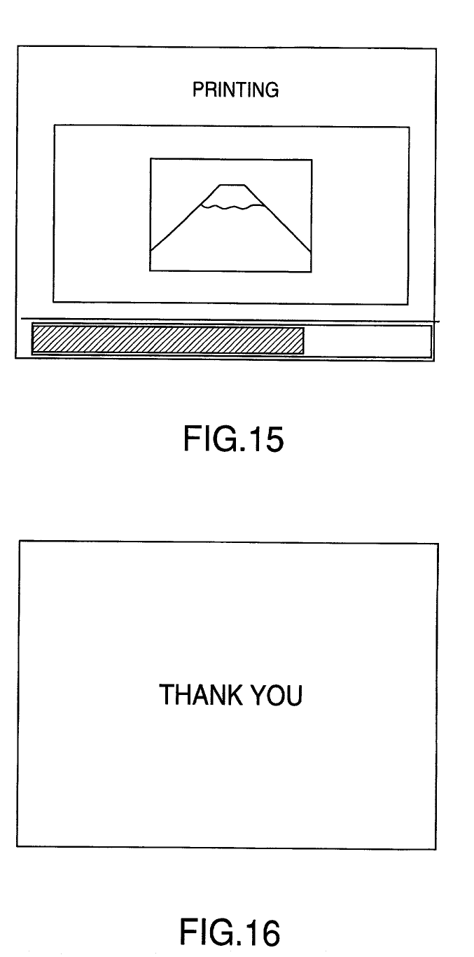

After the completion of the accounting process, a receipt is issued and is delivered to the receipt outlet 30. Subsequently, an instruction picture as shown in FIG. 14 is displayed. The instruction picture includes a message, “Remove the document from the scanner and press the print start button” and a print start button. When the image recording medium is removed from the electronic image data recording medium reader 6b or the document is removed from the support plate of the scanner 6a, and then the print start button is touched, the output unit 12 starts a printing operation. A picture as shown in FIG. 15 is displayed. The picture shown in FIG. 15 includes a message “The printing apparatus is in operation”, a picture of an image being printed, and a time line roughly indicating the progress of the printing operation. Prints are delivered to the reference print outlet 36 of the main unit 1. Then, an ending picture as shown in FIG. 16 is displayed. The monitor 5 displays the end picture for a predetermined time, and changes the end picture for the starting picture.

Although the printing apparatus in the first embodiment, i.e., a printing apparatus having a color-correction function, has been described, the present invention is not limited thereto and various modifications thereof are possible. As apparent from the foregoing description, the printing apparatus of the present invention having a color-correcting function and capable of carrying out a color-correcting method reduces the difference of the color-developing characteristic of the individual printer from the reference color developing characteristic, and the printing apparatus is capable of being easily maintained by a person with little knowledge and experience.

Second Embodiment

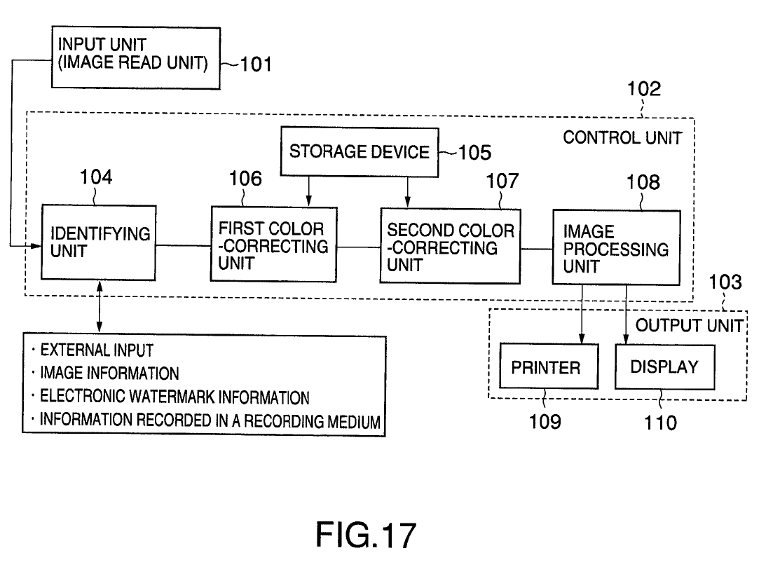

A color-correcting system in a second embodiment according to the present invention will be described hereinafter. Referring to FIG. 17 showing the color-correcting system in the second embodiment, the color-correcting system includes an input unit (image read unit) 101 for converting an original image (analog information), such as a photograph, into image data (digital information), a control unit 102 for correcting the colors of the image data, and an output unit (output device) 103 for printing or displaying an image represented by the color-corrected image data.

The original image is formed in a negative film, a printed photograph, a print printed by an ink-jet printer, a print printed by a sublimation dye transfer printer, a printer or a hard copy.

The image read unit 101 includes a flat-bed scanner. The scanner converts an analog image, such as a photograph, into digital image signals.

The control unit 102 includes a printing system identifying unit 104, a storage device 105, a first color-correcting unit 106, a second color-correcting unit 107, and an image processing unit 108. The printing system identifying unit 104 identifies a printing system by which the original image is printed. For example, the printing system identifying unit 104 is provided with an external input device, such as a touch panel, a keyboard or a mouse. The external input device is operated to enter identification data by which the printing system by which the original image was printed can be identified. As a printing system, for example, a silver salt photographic printing system, a negative film printing system, a positive film printing system, a sublimation dye transfer system, a molten-dye transfer system, an ink-jet printing system, a TA (thermo autochrome) system, an offset printing system, a gravure printing system or the like can be used. A user operates the external input device to enter printing system identification data into the color-correcting system. The storage device 105 stores color-correcting parameters (color correction parameters) and color-modifying parameters (color modification parameters). The color-correcting parameters are values calculated on the basis of characteristic values of a reference document. The color-modifying parameters are values calculated on the basis of characteristic values of reference documents formed respectively by different printing systems. Each of the color-modifying parameters has a plurality values for different printing systems. The first color-correcting unit 106 corrects the colors of image signals provided by the image read unit 101 to change the image signals in accordance with reference image signals. Color-correcting parameters stored in the storage device 105 are used for color correction. The color-correcting parameters are extracted from the storage device 105 in response to demand by the first color-correcting unit 106. The second color-correcting unit 107 modifies the colors of the image signals corrected by the first color-correcting unit 106 so that the colors conform to the printing system by which the original image was printed. The color modification uses the color-modifying parameters stored in the storage device 105. The color-modifying parameters for the printing system are extracted from the storage device 105 in response to demand by the second color-correcting unit 107. The image processing unit 108 processes the image signals color-corrected by the first color-correcting unit 106 and color-modified by the second color-correcting unit 107. More specifically, the image signal processing unit processes the color-corrected, color-modified image signals to provide image signals for displaying or printing an image.

The output unit 103 includes a printer 109 and a display 110. An image represented by the image data provided by the image processing unit 108 is displayed by the display 110 or is printed by the printer 109.

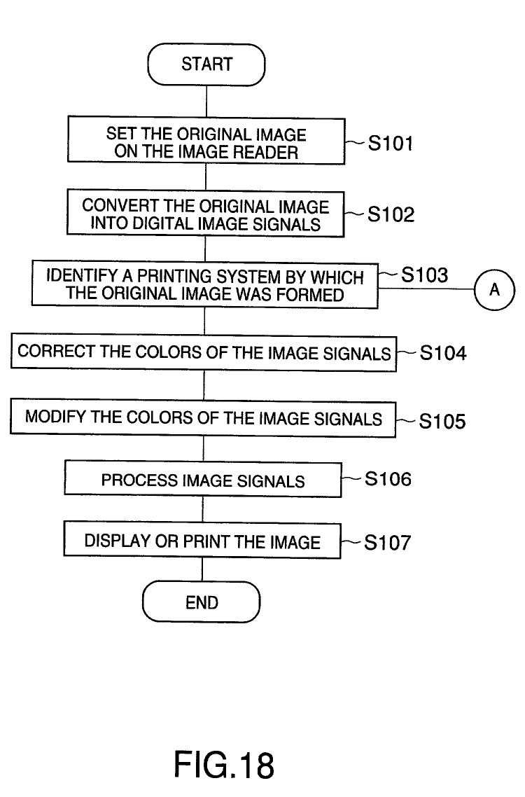

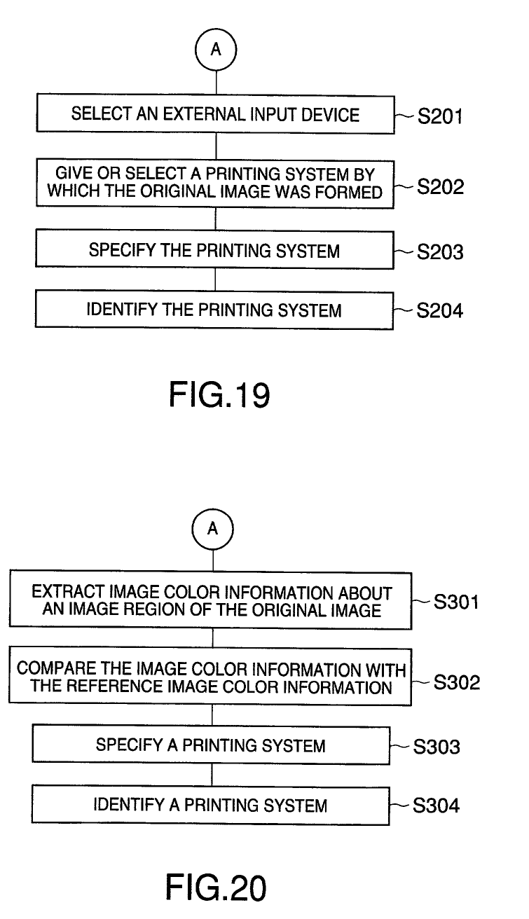

A color-correcting procedure for correcting the colors of an image will be explained. FIG. 18 is a flow chart of a color-correcting procedure and FIG. 19 is a flow chart of a printing system identifying procedure. An original image is set on an image reader in step S101, and the image reader provides digital image signals representing the original image in step S102. In step S103, the printing system identifying unit 104 identifies a printing system by which the original image was formed by identification data provided by an external input device. In step S201, an external input device to be used for providing the identification data is selected. The external input device is a keyboard, a mouse or a touch panel. In step S202, a printing system by which the original image was formed is give or selected after the selection of the external input device, the printing system is specified in step S203 and is identified in step S204. Then in step S104, the first color-correcting unit 106 performs color-correction of the image signals by using color-correcting parameters read from the storage device 105. Then in step S105, the second color-correcting unit 107 reads color-modifying parameters for the printing system identified by the printing system identifying unit 104 from the storage device 105 and performs color-modification of the image signals. The output unit subjects the modified image signals to image processing in step S106 and displays an image represented by the image signals by a display or prints the same by a printer in step S207.

The color-correcting system includes the image read unit 101 capable of converting an analog image into digital image data, the printing system identifying unit 104 for identifying the printing system by which the analog image was printed, the storage device 105 storing the color-modifying parameters for the identified printing systems, and color-correcting parameters for reproducing reference colors, the first color-correcting unit 106 for correcting the colors of the digital image signals by using the color-correcting parameters, the second color-correcting unit 107 for modifying the digital image signals provided by the image read unit 101, and the output unit 103 for providing an image represented by the image signals corrected and modified by the first color-correcting unit 106 and the second color-correcting unit 107 respectively. The color-correcting system identifies a printing system by which the original image was formed on the basis of data provided by the external input device, such as a keyboard, a mouse or the like.

The printing system identifying unit 104 may use any one of various printing system identifying methods. FIGS. 20 to 22 are flow charts of other possible printing system identifying methods. The printing system identifying methods shown in FIGS. 20, 21 and 22 identify the printing system by image information about the original image an electronic watermark marked on the original image, and a recording medium accompanying the original image, respectively.

The printing system identifying method using the image information stores image color information about sample images beforehand, and identifies a printing system by comparing the image color information about an image region of the original image with the previously stored image color information about the sample images. Referring to FIG. 20, the printing system identifying unit 104 extracts image color information about an image region of the original image in step S301. The image color information is compared with the previously stored reference image color information in step S302, a printing system corresponding to the reference image color information coinciding with the image color information about the original image is specified in step S303, and the printing system by which the original image was formed is identified in step S304.

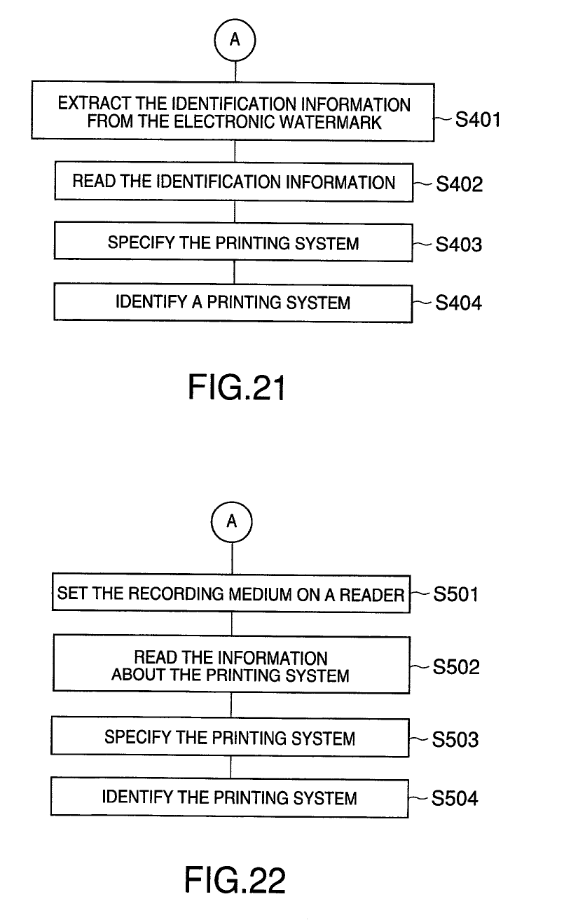

The printing system identifying method identifies a printing system by which the original image was formed by the electronic watermark marked on the original image marks representing the identification information identifying the printing system, and reads the identification information to identify the printing system by which the original image was formed. Referring to FIG. 21, the printing system identifying unit 104 extracts the identification information from the electronic watermark marked on the original image in step S401, reads the identification information in step S402, specifies the printing system in step S403 and identifies a printing system in step S404.

The printing system identifying method that identifies the printing system by a recording medium including the printing system, accompanying the original image, to identify the recording system. The recording medium is not limited to a FD, a PC card or a smart card, and may be an index print or a bar code recorded on the original image so as to be readable. The recording medium is appended to the original image. Referring to FIG. 22, the recording medium is set on a reader capable of reading the information stored in the recording medium in step S501, the information about the printing system recorded in the recording medium is read in step S502, the printing system is specified from the recorded information in step S503 and the printing system is identified in step S504.

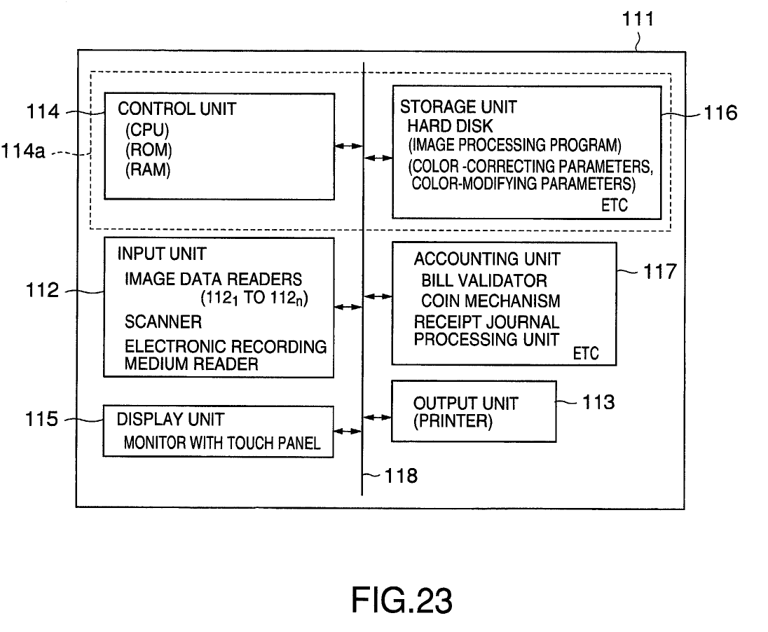

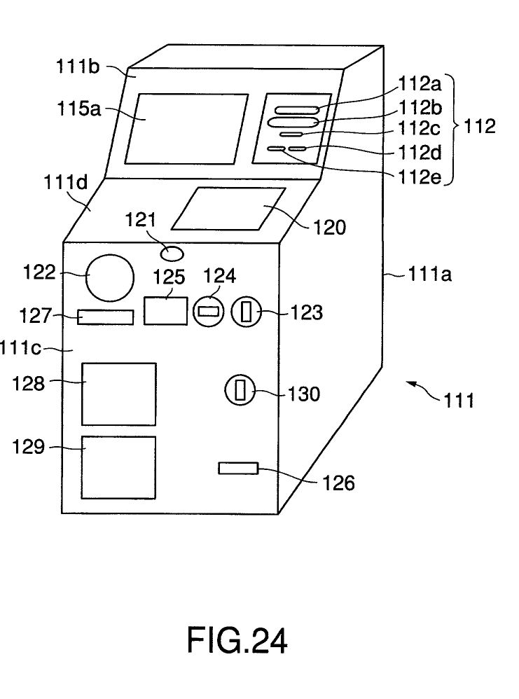

FIG. 23 is a block diagram of a printing apparatus forming the color-correcting system in the second embodiment, and FIG. 24 is a perspective view of the printing apparatus shown in FIG. 23.

Referring to FIGS. 23 and 24, a printing apparatus (color-correcting system) 111 includes an input unit 112 for entering image data, an output unit 113 for making an image represented by the image data, a control unit 114 that performs control operations for controlling operations including input and output operations, a display unit 115 for displaying an operating procedure, a storage unit 116 storing programs defining procedures including the operating procedure and a printing procedure, color-correcting and color-modifying parameters for color correction; and an accounting unit 117 for collecting charges on printing, which are interconnected by a bus 118.

The input unit 112 includes the image data readers 112₁ to 112ₙ of different systems respectively for different image data recording mediums. Each of the image data readers 112₁ to 112ₙ may be a scanner that reads an analog image data and provides digital image data or an electronic image data recording medium reader capable of reading digital image data recorded on an electronic image data recording medium. The electronic image data recording medium is, for example, a FD, a PC card, an MO, a smart card or a CF card. Image data recorded in the user's recording medium can be read by the image data reader of a suitable system.

The output unit 113 includes output devices capable of providing an analog image, such as a photograph, represented by the input image data. The output device is, for example, a printer. Preferably, the printer is a sublimation dye transfer printer.

The control unit 114 includes a CPU, a ROM, a RAM and such for controlling the flow of data (information) and temporarily storing data.

The storage unit 116 includes a hard disk, i.e., a large-capacity data storage medium. Programs are stored in the hard disk. The control unit 114 controls the units connected thereto by the bus 118 according to the programs stored in the hard disk. A color-correcting image processing program for correcting the colors of an input image and necessary programs are stored in addition to the print control program, the accounting program and such in the hard disk of the storage unit 116. The control unit 114 calls a necessary program from the hard disk for a necessary control operation. For example, the control unit 114 executes an image processing program to change input image signals provided by the input unit 112 into image signals capable of reproducing an image of optimum colors by correcting the color characteristic of the input image signals by using color-correcting and color-modifying parameters stored in the storage unit 116.

The control unit 114 and the storage unit 116 constitute a controller 114a.

The display unit 115 has a monitor provided with a touch panel and displays operator guidance for guiding the user to execute the programs stored in the storage unit 116. The control unit 114 executes control operations selectively according to the operator guidance displayed by the display unit 115 to carry out a series of operations including those for reading the image data and producing prints.

The accounting unit 117 has a coin mechanism, a bill validator and a receipt journal processing unit. The accounting unit 117 executes an accounting process to calculate a charge on the basis of the quality and number of prints required by the user. The coin mechanism and/or the bill validator executes accounting operations including those for inspecting coins and bills for genuineness, identifying denominations of coins and bills, calculating an amount of money, giving change and the like. The receipt journal processing unit prints a print menu, the amount of money paid and the like on a receipt sheet and delivers a receipt.

Referring to FIG. 24 showing the printing apparatus 111, a touch panel included in a monitor 115a is placed on the front wall of an upper part of a main unit 111a. The touch panel is the screen of a CRT or a liquid crystal display panel. The monitor 115a serves both as a display means for displaying operator guidance, condition of operations, input or processed image and such, and as an input means for entering orders and data.

The input unit 112 for entering image data is disposed beside the touch panel of the monitor 115a. The input unit 112 is provided with image data recording medium receiving slots 112a to 112e for image data readers respectively capable of reading image data from various recording mediums. A support plate 120 included in the scanner for reading image data formed on various recording mediums and providing digital image data is disposed on a horizontal part 111d between the upper part 111b and a lower part 111c of the main unit 111a.

The image data recording medium receiving slots 112a to 112e are a FD receiving slot 112a, a CD-ROM receiving slot 112b, a PC card receiving slot 112c, a smart media receiving slot 112d and a CF card receiving slot 112e.

A maintenance key 121, a loudspeaker 122, a coin deposition slot 123, a coin returning lever 124, a bill deposition slot 125, a change outlet 126, a receipt outlet 127, a reference print outlet 128 for delivering a reference print, a cut print outlet 1297 for delivering cut printed sheets, and a front-door lock 130 are arranged on a front door covering the open front side of the lower part 111c of the main unit 111a.

The maintenance key 121 is operated to select an operating mode for accepting a user or a management mode for setting the printing apparatus and carrying out maintenance work by a managing person. When the management mode is selected, color correction can be performed, when necessary, to obtain a printed image of colors corresponding to the reference color development characteristic information. The loudspeaker 122 radiates voices, background music, sound effect or the like while the printing apparatus is in waiting or in operation.

A charge is paid by depositing bills through the bill deposition slot 125 or depositing coins through the coin deposition slot 123. The coin returning lever 124 is operated in such a case where a coin deposition path is clogged with coins. When the coin returning lever 124 is turned or when change is given, coins are delivered through the change outlet 126.

A receipt issuing device disposed inside the main unit 111a issues a receipt on which the amount of money collected and orders made by the user are printed, and delivers the receipt through the receipt outlet 127.

Prints printed by output devices disposed inside the main unit 111 are delivered to the reference print outlet 128 and the cut print outlet 129.

The front-door lock 130 is operated to open the front door for the maintenance of the devices installed inside the main unit 111. Installed inside the main unit 1 are internal parts associated with the touch panel of the monitor 115a, the image data recording medium receiving slots 112a to 112e and the support plate 120 of the scanner. A volume adjusting device for the loudspeaker 122 is disposed inside the main unit 111. Also installed in the main unit 111 in connection with the coin deposition slot 123, the coin returning lever 124, the bill deposition slot 125 and the change outlet 126 are the coin mechanism (coin processing device) for identifying, storing and delivering coins, the bill validator (bill processing device) and a safe for storing coins when the coin mechanism is filled with coins up to its full capacity. A receipt printer is combined with the receipt outlet 127. A printer is combined with the reference print outlet 128 and the cut print outlet 129.

Although not visible from outside, a microcomputer including the control unit 114, a power box for voltage transformation, and an uninterruptive power supply for preventing damage to the CPU of the control unit 114 and the hard disk in case of power failure are disposed inside the main unit 111.

Although the color-correcting system included in the printing apparatus has been described, the present invention is not limited thereto and various modifications thereof are possible. As apparent from the foregoing description, the present invention is not limited to the printing apparatus described herein and may be embodied in various printing apparatuses.

What is claimed is:

1. A color-correcting method comprising the steps of:
inputting image data into an input unit;
correcting the image data input into the input unit by using output-correcting values by a controller to obtain color-corrected image data; and
printing an image represented by the color-corrected image data corrected by the controller by an output.

2. The color-correcting method according to claim 1 further comprising the steps of:
printing a test image by the output unit on the basis of test image data carrying reference color development characteristic information;
reading the printed test image by the input unit to obtain the image data; and
calculating the output-correcting values by the controller on the basis of the differences between the color development characteristic information included in the test image data read by the input unit and the reference color development characteristic information.

3. A color-correcting system comprising:
an input unit that receives image data;
a controller storing output-correcting value, for correcting the image data received by the input unit by using the output-correcting values; and
an output unit that prints an image on the basis of the corrected image data obtained by correcting the image data by the controller.

4. The color-correcting system according to claim 3, wherein
the controller has test image data including reference color development characteristic information, the input unit reads the test image printed on the basis of the test image data by the output unit, and
the controller calculates output-correcting values on the basis of the difference between the color development characteristic information included in the test image data read by the input unit and the reference color development characteristic information.

5. The color-correcting system according to claim 3, wherein
the controller changes the output-correcting values in accordance with printing conditions.

6. The color-correcting system according to claim 3, wherein
the controller stores a plurality of sets of output-correcting values and selects an appropriate set of output-correcting values in accordance with printing conditions.

7. The color-correcting system according to claim 3, wherein
the output unit is a sublimation dye transfer printer.

8. A color-correcting method comprising the steps of:
reading a printed image by an input unit to obtain image data, and
modifying the image data read by the input unit by a controller by using color modification parameters corresponding to a printing system by which the printed image was formed.

9. The color-correcting method according to claim 8 further comprising the step of identifying the printing system by which the printed image was formed and specifying desired color modification parameters by the controller.

10. A color-correcting system comprising:
an input unit that reads a printed image to obtain image data; and
a controller that modifies the image data provided by the input unit by using color modification parameters corresponding to a printing system by which the printed image was formed.

11. The color-correcting system according to claim 10, wherein
the controller stores a plurality of sets of color modification parameters respectively corresponding to a plurality of printing systems, identifies a printing system by which the printed image was formed, and specifies a desired set of color modification parameters.

12. The color-correcting system according to claim 10 further comprising an output unit that prints an image on the basis of the image data modified by the controller.

13. The color-correcting system according to claim 10, wherein the input unit is a flat-bed scanner.

14. The color-correcting system according to claim 11, wherein
the controller identifies the printing system by which the printed image was formed on the basis of external data given thereto.

15. The color-correcting system according to claim 11, wherein
the controller identifies the printing system by which the printed image was formed on the basis of electronic watermark information included in the image data obtained by reading the printed image.

16. The color-correcting system according to claim 11, wherein
the controller identifies a printing system by which the printed image was formed on the basis of information provided by an information storage medium storing printing systems by which the printed images were formed.

17. The color-correcting system according to claim 11, wherein
the controller corrects the image data provided by the input unit by using color correction parameters stored therein.
